(19) United States
(12) Patent Application Publication
(10) Pub. No.: US 2026/0092844 A1
(43) Pub. Date: Apr. 2, 2026

(54) PRECOMPRESSION TENSILE KOLSKY BAR SYSTEM

(71) Applicant: United States of America as Represented by The Secretary of The Army, Alexandria, VA (US)

(72) Inventors: Brett A Williams, Vicksburg, MS (US); Danny J. Frew, Albuquerque, NM (US); Xu Nie, Plano, TX (US); William F. Heard, Clinton, MS (US)

(73) Assignee: United States of America as Represented by The Secretary of The Army, Alexandria, VA (US)

(21) Appl. No.: 18/900,806

(22) Filed: Sep. 29, 2024

(51) Int. Cl. G01N 3/10; G01N 3/04

(52) U.S. Cl. CPC G01N 3/10; G01N 3/04

(57) ABSTRACT

A loading apparatus includes an incident bar and a transmission bar coaxial with a specimen along a longitudinal axis. A loading gun has a gun barrel and a striker bar inside the gun barrel. The incident bar is disposed between the gun barrel and the specimen. A reaction spring is disposed between the gun barrel and a reaction mass. A pulse shaper is disposed between the reaction spring and the striker bar. The striker bar is propelled in a direction from the incident bar to the reaction spring to strike the pulse shaper and compress the reaction spring to apply a dynamic tensile load on the specimen in the direction along the longitudinal axis. A precompression device is coupled to the transmission bar to apply a quasi-static precompressive load on the specimen via the transmission bar before propelling the striker bar to the pulse shaper to generate the dynamic tensile load.

### CROSS-REFERENCE TO RELATED APPLICATIONS

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to measuring material properties and, more specifically, to devices and methods for measuring dynamic properties of brittle materials.

### Description of the Related Art

This section introduces aspects that may help facilitate a better understanding of the invention. Accordingly, the statements of this section are to be read in this light and are not to be understood as admissions about what is prior art or what is not prior art.

Tension-induced dynamic fragmentation is often observed on the back side of the penetration/perforation targets as a result of stress wave reflection from the free surface. Tensile/spall damages generated during the fragmentation process significantly compromise the penetration resistance of the target material, which leads to reduced protection capability. This unique challenge is further exacerbated by the lack of a reliable dynamic tensile characterization system for brittle materials. Over the past several decades, some efforts have been made to develop a Kolsky bar-based dynamic tensile testing technique using the ideas of spall tension, split tension, and direct tension. The split-Hopkinson pressure bar (SHPB), named after Bertram Hopkinson, sometimes also called a Kolsky bar, is a loading apparatus for testing the dynamic stress-strain response of materials.

Tension testing in a Split Hopkinson pressure bar (SHPB) is more complex due to a variation of loading methods and specimen attachment to the incident bar and transmission bar. The first tension bar was designed and tested in 1960; the design involved using a hollow weight bar that was connected to a yoke and threaded specimen inside of the weight bar. A tensile wave was created by impacting the weight bar with a ram and having the initial compression wave reflect as a tensile wave off the free end. Another breakthrough in the SHPB design was done by Nichols who used a typical compression setup and threaded metallic specimens on both the incident and transmission ends, while placing a composite collar over the specimen. The specimen had a snug fit on the incident and transmission side in order to bypass an initial compression wave. Nichols'setup would create an initial compression wave by an impact in the incident end with a striker, but when the compression wave reached the specimen, the threads would not be loaded. The compression wave would ideally pass through the composite collar and then reflect off the free end in tension. The tensile wave would then pull on the specimen. The next loading method was revolutionized in 1984. A hollow striker was used to impact a flange that is threaded to the end of an incident bar. This striker was propelled by using either a gas gun or a rotating disk. The specimen was once again attached to the incident bar and transmission bar via threading.

Characterizing the limited tensile strain capacity of brittle material under dynamic tensile loads has historically been a challenge. Prior techniques and their associated disadvantages are discussed at great length in W. Heard, B. Song, B. Williams, B. Martin, P. Sparks, X. Nie, “Dynamic tensile experimental techniques for geomaterials: a comprehensive review,” Journal of Dynamic Behavior of Materials, Vol. 4, 74-94 (2018). A common drawback of all these techniques is that the specimens rarely reached the state of stress equilibrium or constant strain-rate deformation at the time of fracture due to extremely small tensile failure strain for most of the brittle materials.

### SUMMARY

A tensile Kolsky bar technique can be utilized to measure the response of brittle materials, such as rocks and concretes, in a state of uniaxial dynamic stress equilibrium and constant strain rate. For an ideal Kolsky compression bar process, the sample should be in dynamic stress equilibrium and deform at a nearly constant strain rate (±5%) over most of the duration of the process (50% to 100%). Due to the low-tensile-strength and strain-to-failure behavior of the brittle materials, it is difficult to achieve such conditions in a traditional Kolsky bar tensile test before specimen failure is achieved. Since these physical metrics have not been achieved during testing, the validity of the experimental data is therefore questionable. Specifically, the state-of-stress and the strain-rate at failure metrics are difficult to determine in a traditional Kolsky bar tensile test.

To address this challenge, the present technique applies an elastic axial compressive preload to the test specimen before a dynamic load is applied through a modified tensile Kolsky bar system. During the initial tensile loading of the test specimen from the incident bar, the precompressive load on the test specimen will be negated while allowing the specimen to equilibrate load and strain-rate through the specimen at lower mean values and therefore earlier into the experiment. The design allows the preload to be adjustable to account for different material types and can be applied at a sufficiently low-level to restrict the test specimen from being plastically damaged before the dynamic tensile load is applied. Finally, novel pulse-shaping and specimen grip designs are presented and demonstrated in this effort to address potential risk features of this technique.

According to an embodiment, a novel Kolsky tension bar technique is capable of testing brittle materials under constant strain rate and dynamic stress equilibrium. Specifically, a precompression mechanism is adopted to impose initial static compressive stress to the tensile specimen. As a result, higher dynamic tensile strain rate can be achieved during the unloading phase of the compressive deformation. With this new technique, brittle materials such as concrete can be tested at high tensile rates comparable to those achieved in dynamic compression.

According to an aspect of the present invention, a loading apparatus comprises an incident bar and a transmission bar coaxial with a specimen along a longitudinal axis to be loaded in a direction along the longitudinal axis. The incident bar and the transmission bar are coupled to the specimen on opposite sides of the specimen. The incident bar and the transmission bar are supported on a platform. A loading gun has a gun barrel and a striker bar inside the gun barrel which are coaxial with the incident bar. The gun barrel is coupled to the incident bar. The incident bar is disposed between the gun barrel and the specimen. The gun barrel is supported on the platform. A reaction mass is mounted on the platform. A reaction spring is disposed between and coupled with the gun barrel and the reaction mass. A pulse shaper is disposed between the reaction spring and the striker bar. The striker bar is configured to be propelled in a direction from the incident bar to the reaction spring to strike the pulse shaper and compress the reaction spring to apply a dynamic tensile load on the specimen in the direction along the longitudinal axis. A precompression device is coupled to the transmission bar which is disposed between the specimen and the precompression device. The precompression device is configured to apply a quasi-static precompressive load on the specimen in the direction along the longitudinal axis via the transmission bar prior to propelling the striker bar to the pulse shaper to apply the dynamic tensile load on the specimen.

In accordance with another aspect, a dynamic tensile loading method comprises: connecting an incident bar and a transmission bar on opposite sides of a specimen which is coaxial with the incident bar and the transmission bar along a longitudinal axis to be loaded in a direction along the longitudinal axis; connecting a loading gun to the incident bar, the loading gun having a gun barrel and a striker bar inside the gun barrel which are coaxial with the incident bar, the gun barrel being coupled to the incident bar, the incident bar being disposed between the gun barrel and the specimen; mounting a reaction mass on a platform; connecting a reaction spring between the gun barrel and the reaction mass; applying a quasi-static precompressive load to the specimen in the direction along the longitudinal axis via the transmission bar to provide a precompressed specimen; and propelling the striker bar in a direction from the incident bar to the reaction spring to strike and compress the reaction spring to apply a dynamic tensile load on the specimen in the direction along the longitudinal axis.

In accordance with yet another aspect, a loading apparatus comprises: an incident bar and a transmission bar coaxial with a specimen along a longitudinal axis to be loaded in a direction along the longitudinal axis, the incident bar and the transmission bar being coupled to the specimen on opposite sides of the specimen; a loading gun having a gun barrel and a striker bar inside the gun barrel which are coaxial with the incident bar, the gun barrel being coupled to the incident bar, the incident bar being disposed between the gun barrel and the specimen; a reaction mass; a mechanism or means coupled to the reaction mass for receiving impact by the striker bar and, in response thereto, generating an incident pulse in the incident bar and transmit the incident pulse to apply a dynamic tensile load on the specimen; and a precompression device coupled to the transmission bar which is disposed between the specimen and the precompression device, the precompression device configured to apply a quasi-static precompressive load on the specimen in the direction along the longitudinal axis via the transmission bar prior to propelling the striker bar to the means to apply the dynamic tensile load on the specimen.

In some embodiments, the means comprises a mechanism or means for generating the incident pulse to apply the dynamic tensile load on the specimen in dynamic stress equilibrium at a substantially constant strain-rate deformation over a substantial portion (most) of a loading duration of the dynamic tensile load on the specimen.

In specific embodiments, the means comprises a modular mechanism or modular means which are replaceable in a modular manner to adjust the incident pulse generated in response to receiving impact by the striker bar for different specimens, for applying the dynamic tensile load on the specimen in dynamic stress equilibrium at a substantially constant strain-rate deformation over a substantial portion (most) of a loading duration of the dynamic tensile load on the different specimens.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a perspective view of an overall schematic of a precompression Kolsky tension bar system according to an embodiment.

FIG. 2 is a perspective view illustrating an example of the air gun and reaction mass section of the designed precompression Kolsky bar system of FIG. 1.

FIG. 3 is an elevational view of the air gun and reaction mass section of FIG. 2.

FIG. 4 is a cross-sectional view of an impact section of the air gun of FIG. 1.

FIG. 5 is a cross-sectional view of a tensile-barrel-to-incident-bar interface of FIG. 1.

FIG. 6 is an elevation view of a tensile-barrel-to-incident-bar interface of FIG. 5.

FIG. 7 shows an example of specimen mounting in the precompression Kolsky tension bar system of FIG. 1.

FIG. 8 is a cross-sectional view of a precompression hydraulic chamber of the precompression hydraulics.

FIG. 9A shows a first perspective view of a pressure intensifier. FIG. 9B shows a second perspective view thereof. FIG. 9C shows a cross-sectional view thereof.

FIG. 10A shows tensile grips. FIG. 10B shows a cylindrical concrete tensile specimen.

FIG. 11 shows (A) a first perspective view and (B) a second perspective view of the cylindrical concrete tensile specimen 1000 with thin copper wires 1100 attached thereto.

FIG. 12 schematically illustrates the use of the copper wire as a spacer to adjust the specimen position of the specimen inside the adapter.

FIG. 13 illustrates a step-by-step procedure of attaching the specimen to the Kolsky tension bar, which has been aligned in advance.

FIG. 14 shows a specimen attached to the Kolsky tension bar.

FIG. 15A shows a typical set of waveforms recorded from one of the dynamic tensile tests including original oscilloscope records of voltage. FIG. 15B shows a typical set of waveforms including corresponding shifted waveforms for a proof-of-concept dynamic tensile test of concrete of bar stress.

FIG. 16 shows the original raw strain gauge signal from a dynamic uniaxial tensile test of HPC specimens.

FIG. 17 shows the dynamic stress equilibrium check for the dynamic tensile test.

FIG. 18 shows the tensile stress-strain curves of the four specimens at the strain rate of ˜7/s.

FIG. 19 is a flow diagram illustrating an example of a precompression tensile Kolsky bar method.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

### 1. Introduction

The pursuit of dynamic tension techniques for brittle materials has long been a challenging subject for the Kolsky bar community. Compared to dynamic compression, a dynamic tensile experiment on brittle materials is more complicated and difficult to accurately conduct. Current dynamic tension techniques are mostly based on Kolsky bar principles with different specimen and testing designs. Using conventional Kolsky tension bars to characterize brittle materials, which commonly is referred to as “direct-tension,” is among some of the earliest proposed techniques. However, this method is challenged in experimental practice with difficulties such as specimen gripping, dynamic stress equilibrium, constant strain-rate deformation, etc. The second dynamic tension technique utilizes a Brazilian disc sample from quasi-static “split-tension” testing and has been applied to Kolsky compression bars for characterizing the dynamic tensile strength of materials. In this method, the disc specimen is loaded diametrically in compression to generate transverse tensile stress along the loading line. Thus, only a small, localized region of the entire specimen is under tensile loading, and material deformation under the loading is very difficult to measure. The third method for dynamic tensile testing of brittle materials is “spall-tension.” When the Kolsky compression bar is used for spall tension experiments, the transmission bar is replaced with a long cylindrical test sample to generate spall-tensile failure. A one-dimensional stress-wave analysis is required to calculate the spall-tensile strength. Much like the split tension technique, specimen deformation under spall-tension is also difficult to measure. Direct-tension, split-tension, and spall-tension are three primary dynamic experimental techniques to measure the dynamic tensile strength of brittle materials. The specimen stress states and corresponding spatial and temporal histories of deformation among these three different types of dynamic tensile experiments are quite different, which often leads to inconsistent dynamic tensile strength measurements. These inconsistencies result in uncertainty of the intrinsic strain-rate effect and related failure mechanisms.

In the early 1980s, a 74-mm-diameter, 11.65-m-high vertical Kolsky tension bar system was developed for dynamic direct-tension tests of concretes and mortars. The resultant stress-strain curves showed that the impact tensile strength for both concretes and mortar was much higher than the quasi-static strength. In addition, the strain at maximum stress was larger than the quasi-static failure strain. The concrete (reported to have a maximum aggregate particle size of 16-mm) and micro-concrete (a concrete described in the work as having a maximum sand particle size of 2 mm) exhibited higher impact tensile strengths than mortar (described as having a maximum sand particle size of 1 mm and lower cement content than both the concrete and micro-concrete) due to direct crack arresting action of the tougher aggregate particles in concretes. Both materials indicated significant strain-rate effects. This facility has claimed to be capable of dynamic single loading tensile testing of steel fiber-reinforced concrete and repeated tensile (fatigue impact) property characterization of concretes as well as dynamic pull-out force measurement for bond tests. Other researchers have resorted to prestressing the Kolsky bar to generate a tensile loading wave for dynamic testing of concrete and other geomaterials. In these efforts, aluminum alloy bars were selected to match the mechanical impedance of the geomaterials. Tensile strain-rates as high as 300/s was reported from these tests, although it was unclear how this strain-rate was determined since no evidence of constant strain-rate deformation was reported in these studies.

In summary, the current direct tension Kolsky bar techniques for concrete and other geomaterials have not proven to provide the same valid testing boundary conditions, e.g., constant strain-rate deformation and dynamic stress equilibrium, as have been achieved in dynamic compression. The main challenge for dynamic tension of concrete is the extreme brittleness for this type of materials. While the strain rate in the test specimen ramps up, the deformation continues to accumulate until failure occurs. The small tensile failure strain of concrete has greatly limited the maximum achievable strain rate. On the other hand, stress equilibrium in a tensile specimen also is difficult with limited specimen deformation. It is believed that the best solution to these two challenges is to extend the tensile deformation to failure during a Kolsky bar test without modifying the material properties. As such, a quasi-static precompressive stress is applied to the specimen prior to the dynamic tensile testing. The magnitude of this precompression needs to be carefully designed so as not to damage the tensile specimen. When the tensile loading wave arrives at the specimen, through the incident bar, the initial deformation caused by this tensile wave is in fact the unloading of the compressive stress. Since concrete can sustain significantly more deformation in compression than in tension, this initial unloading of the compressive stress will provide a substantial buffer zone for the tensile strain-rate to rise. Once the initial compression in the specimen has been completely released and tensile stress starts to accumulate, the tensile specimen will already be under constant strain-rate deformation and dynamic stress equilibrium.

### 2. Loading Apparatus

An innovative Kolsky tension bar system has been developed to characterize the dynamic tensile behavior of brittle materials at high strain rates. Limited tensile strain capacity of brittle material has historically been a challenge to characterize under dynamic tensile loads. A solution is needed to impose a static compressive stress to the test specimen prior to the arrival of dynamic tensile loading wave, thus augmenting the total loading duration to facilitate dynamic stress equilibrium and constant strain-rate deformation of the specimen. Ideally, this static compressive stress would be capable of a prestress of 0-100 MPa so that the technique would be applicable to high-strength concrete, ultra-high-performance concrete, glass, or ceramics.

The novel Kolsky tension bar technique is capable of testing brittle materials under constant strain rate and dynamic stress equilibrium. A precompression mechanism or precompression device is adopted to impose initial static compressive stress to the tensile specimen, thereby achieving a higher dynamic tensile strain rate during the unloading phase of the compressive deformation. Consequently, brittle materials such as concrete can be tested at high tensile rates comparable to those achieved in dynamic compression.

According to embodiments, a modified Kolsky tension bar system adds axial precompression through a hydraulic chamber placed at the end of the transmission bar. Due to the relatively low axial precompression loads, the reactionary platform on the system can be achieved through the test platform, a hydraulic accumulator, and a reaction mass.

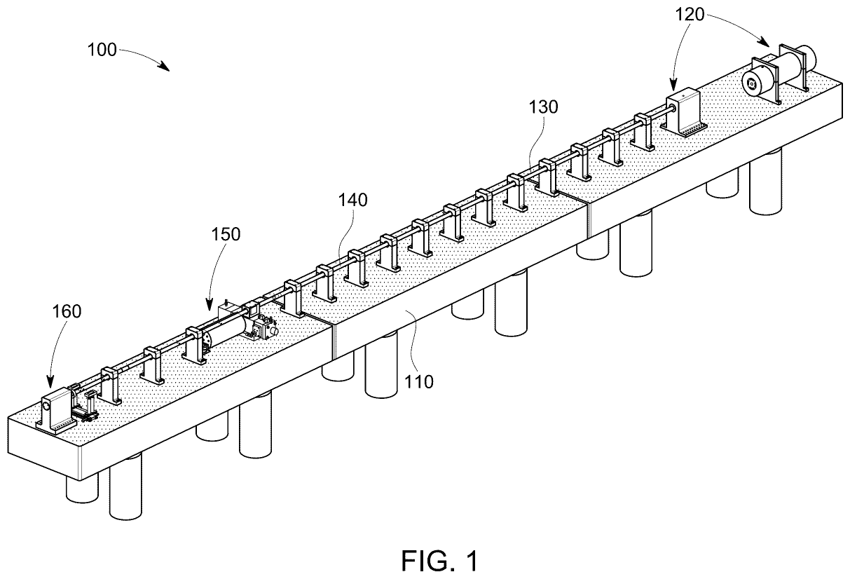

FIG. 1 is a perspective view of an overall schematic of a precompression Kolsky tension bar system 100 according to an embodiment. Disposed on a test platform 110 are precompression hydraulics 120, a transmission bar 130, an incident bar 140 which is coaxial with the transmission bar along a longitudinal axis, an air gun system 150, and a reaction mass 160. The system is designed not only for performance and capability but also for ease of use and repeatability.

In a traditional direct-tensile Kolsky bar system, a one-dimensional tensile-wave is created in the incident bar 140 resulting in a tensile loading pulse or incident pulse on the test specimen with the created wave. The test specimen is typically epoxied to the incident bar 140 and transmission bar 130 and thus results in a one-dimensional axial load being applied to the specimen. Strain gauges on the transmission bar 130 and incident bar 140 are used to measure the strain-rate as well as the load equilibrium in the specimen as a function of time as well as the strain-rate.

Although the general concept of this system is the same as that of a traditional tensile system, modifications are necessary to allow for a precompression load to be applied while still allowing the tensile loading pulse to not be affected during the experiment.

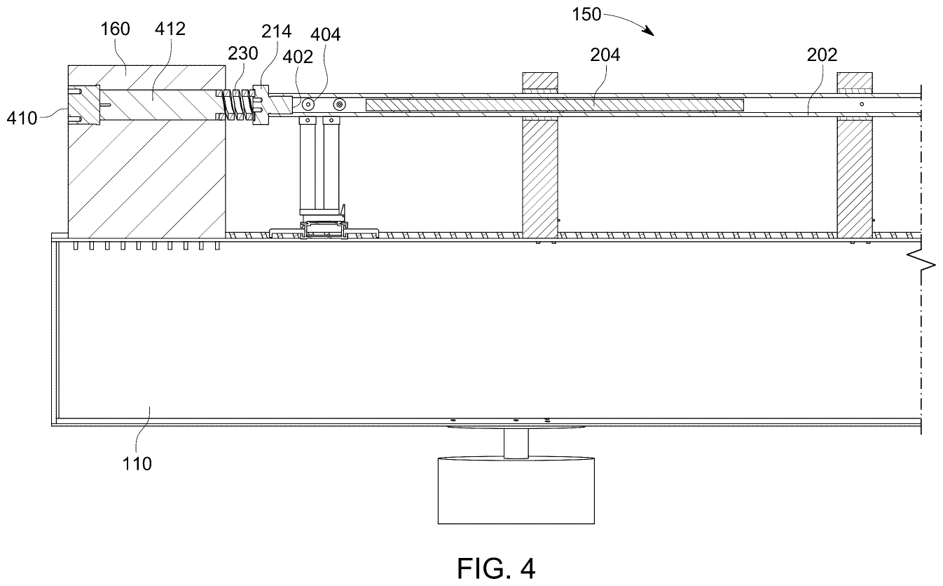

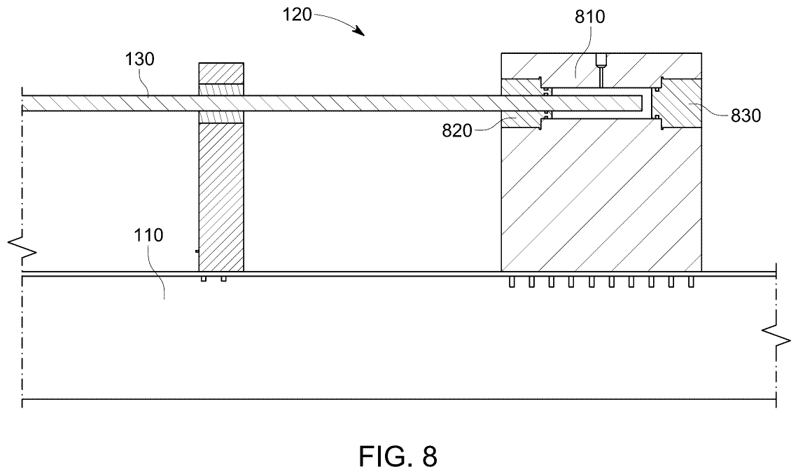

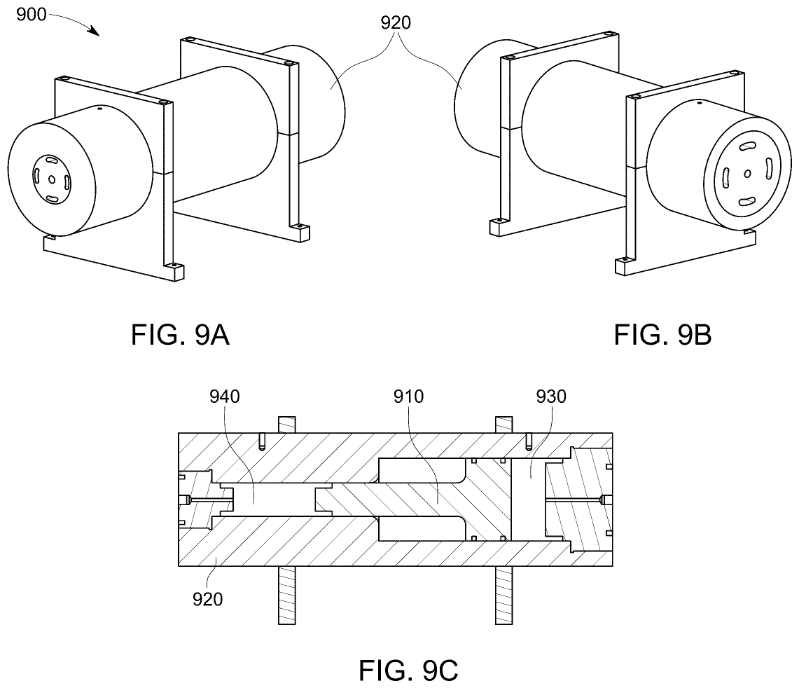

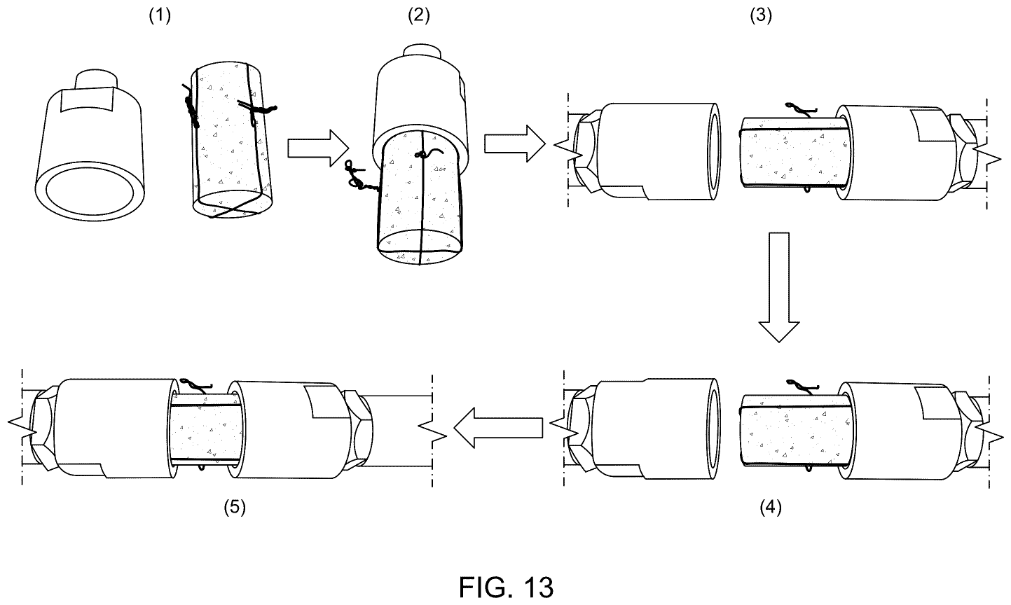

The novel Kolsky tension bar system includes a reaction spring design for simplified pulse shaping (FIG. 4), a custom precompression hydraulic chamber with intensifier (FIGS. 8 and 9), and a successful dynamic gripping technique for high-strength concrete (FIGS. 13-15). The following will describe the design features of the modified tensile Kolsky system, initial testing results of the critical features of the design, and initial pulse-shaper designs for testing brittle materials in the tensile Kolsky system.

### 2.1 Air Gun System and Reaction Mass

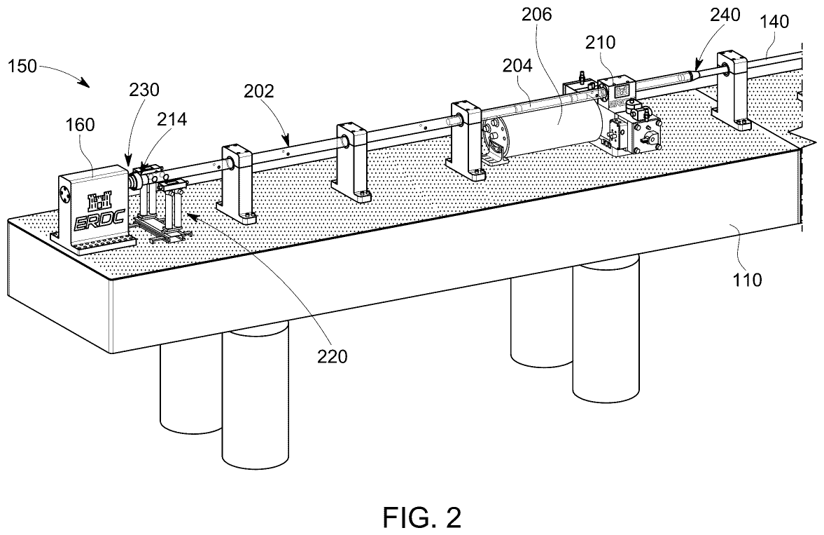

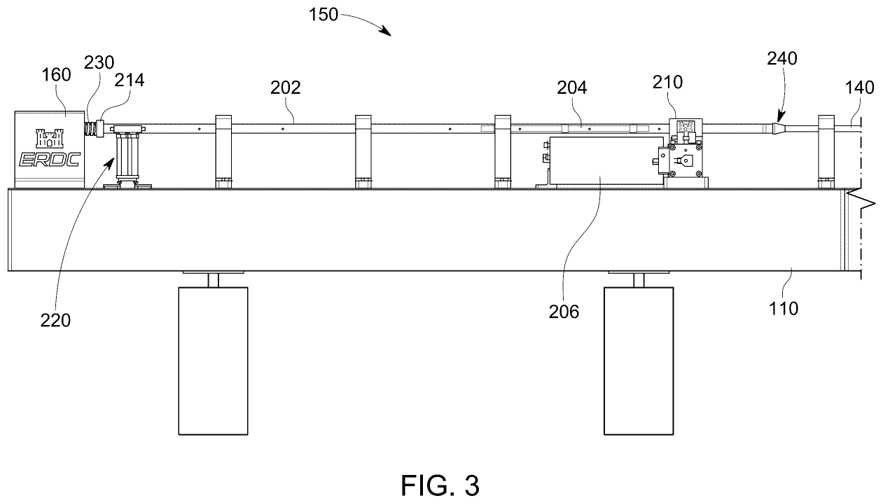

FIG. 2 is a perspective view illustrating an example of the air gun and reaction mass section of the designed precompression Kolsky bar system 100 of FIG. 1. FIG. 3 is an elevational view thereof. FIG. 4 is a cross-sectional view of an impact section of the loading gun or air gun 150 of FIG. 1. The overall purpose of the air gun section 150 of the device is to launch a striker bar 204 into a reaction plug 214 that is attached to one end of the air gun barrel 202 which is coaxial with the incident bar 140. Gas pressure to the gas accumulator 206 and a fast-acting valve 210 dynamically provides the air gun barrel 202 with compressed gas. An example is a spool valve that operates independently of inlet pressure with opening times of less than 2 msec and pressures up to 6,000 psi. Other types of fast-acting valve may be used as well. A barrel coupler 240 is disposed between an end of the air gun barrel 202 in air gun section 150 and the incident bar 140. When operated, the valve 210 will repeatably open within 3-5 msec and result in extremely consistent striking velocities and, therefore, reliable loading pulses to the test specimen. The resulting gas pressure applied to the exposed end of the striker bar 204 will propel the striker toward the reaction mass 160 and pulse shaper 402 attached to the end of the reaction plug 214.

A reaction spring design is used for simplified pulse shaping. Prior to impact, the laser velocity system 220 will measure the striking velocity (Vs) of striker bar 204 and aid in analytic pulse shaping prediction tool (i.e., be utilized for pulse-shaper prediction programs). The reaction mass 160 is affixed to the platform 110 to provide a rigid support. It includes a reaction mass system end plug 410 and a reaction spacer 412 which is coupled with the reaction spring 230. The reaction spring and reaction mass assembly are configured to resist the precompression load applied from precompression hydraulics 120 (shown in FIG. 1). The reaction spring 230 has sufficient stiffness to handle the precompression and allow for additional deformation beyond the precompression to produce the tensile wave on the incident bar 140. The resulting impact of the striker bar 204 with the reaction coupler or barrel coupler 240 will create a dynamic tensile loading pulse in the barrel section that will travel from left-to-right in FIGS. 3 and 4. The reaction mass section provides a modular system in which the reaction plug 214 and/or the reaction spacer 412 can be replaced in a modular manner by properly sized alternatives to accommodate a reaction spring 230 of proper dimensions or are replaceable in a modular manner to change the reaction spring 230 for generating the desired tensile wave in a particular brittle sample.

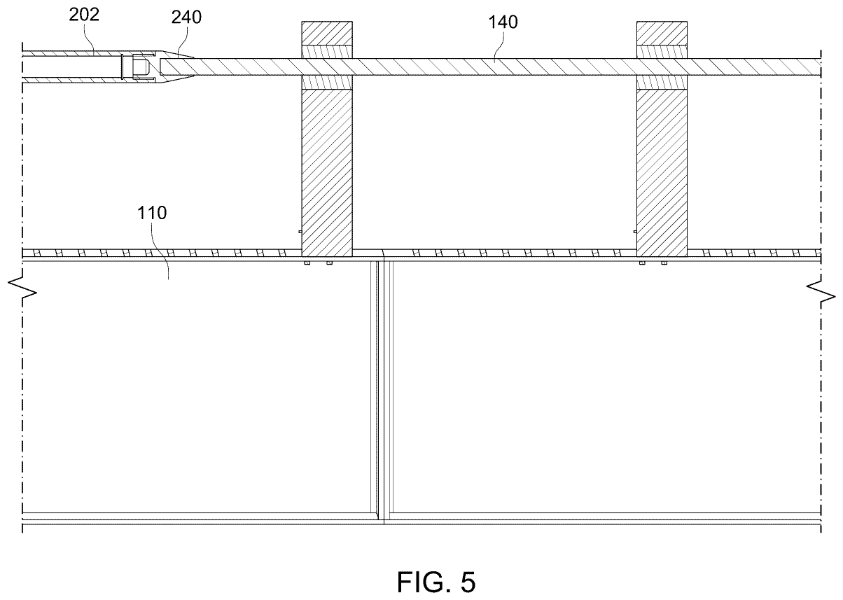

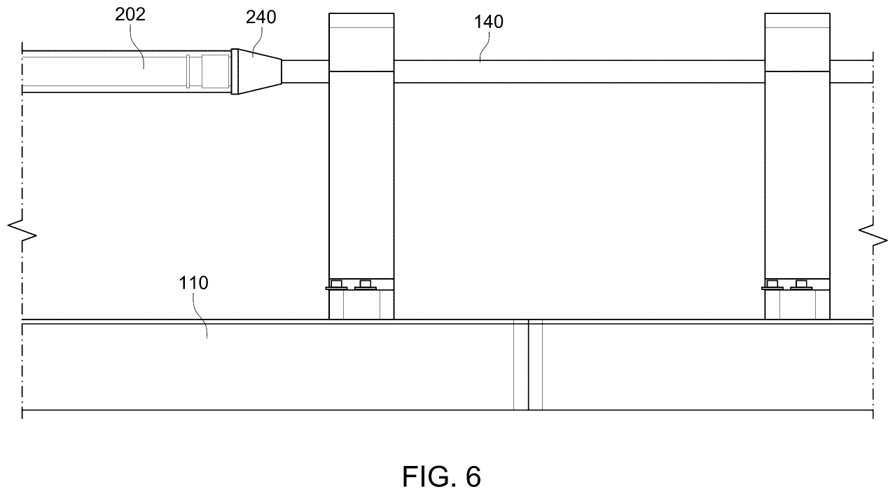

FIG. 5 is a cross-sectional view of a tensile-barrel-to-incident-bar interface of FIG. 1. FIG. 6 is an elevation view thereof. The incident bar/barrel coupler 240 physically connects the barrel section 202 to the incident bar 140 thus allowing the tensile loading pulse to be transmitted into the incident bar 140. To minimize the impedance mismatch between the barrel and incident bar 140, the cross-sectional area of the barrel is optimized to that of the incident bar 140. It is noted that the incident bar/barrel coupler 240 is designed to allow both the air gun barrel 202 and incident bar 140 threads to physically bottom-out on the coupler 240 which allows the load-pulse to travel through the shoulders on the coupler 240 and not through the threads. This will promote a much stiffer transmission of the stress waves between the barrel 202 and incident bar 140 and reduce dispersion waves during this physical transition.

### 2.2 Specimen Mounting

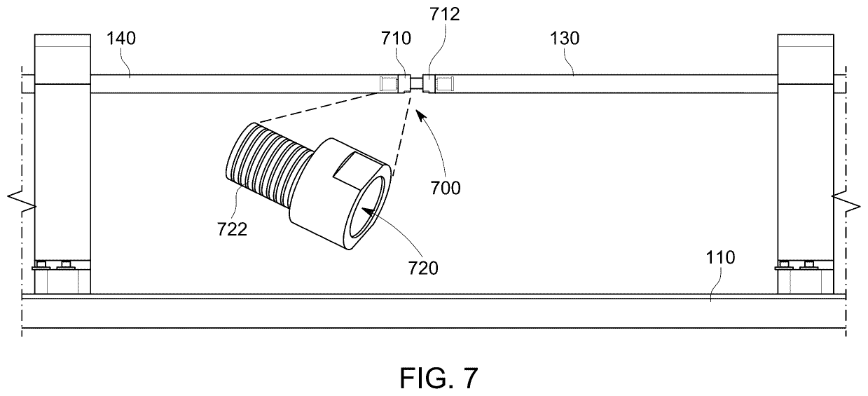

FIG. 7 shows an example of specimen mounting in the precompression Kolsky tension bar system of FIG. 1. Unlike a compression Kolsky bar experiment, the incident bar 140 and transmission bar 130 for the tension system are physically attached to opposite sides of the coaxial test specimen 700 to transmit a tensile pulse through the sample in a longitudinal direction along a longitudinal axis. A common technique for testing metals in a tensile Kolsky bar is to physically thread the test specimen onto the Kolsky bars. Threading test specimens on rocks and concretes is not an option; therefore, a technique employing tensile grips 710, 712 was developed, as seen in FIG. 7. Both the incident bar 140 and transmission bar 130 are threaded to accept dual tensile grips 710, 712 that sandwich the test specimen 700 into the system. The tensile grips 710, 712 each include a specimen mount 720 for mounting the specimen 700 and a threaded end 722 for threadingly coupling with the incident bar 140 or the transmission bar 130. The specimen mount locations accept the right-circular-cylinder specimen and allow for epoxy cement to hold the specimen during the test. Data show that the epoxy mounting technique works and that the failure of the tensile sample occurs away from the tensile grips as designed. It is noted that the tensile grips 710, 712 have opposing threads (Right and Left-Hand) to allow for the test specimen to be threaded onto the incident bar 140 and transmission bar 130 without having to spin the bars and possibly damage the strain gauges. The specimen mounting is capable of providing a smooth compression to tension transition. In sum, the pair of tensile grips 710, 712 grip the specimen 700 at opposite ends of the specimen along the longitudinal axis, each tensile grip including a grip cavity 720 to receive a portion of the specimen to be glued to the grip cavity and a threaded end 722 to threadingly receive a portion of the incident bar 140 or the transmission bar 130.

An anticipated challenge with the precompression methodology is preventing motion caused by slippage in the test specimen holders. Traditional sample holders for compression tests use small amounts of adhesive at the sample ends to hold the sample in place until compression begins. For Kolsky tensile samples, a traditional dog-bone shaped sample is often used that allows a holder to grip the flared portion just beyond the gauge section. Neither of these configurations has been designed to appropriately support a sample subjected to both tension and compression. For the adhesion method, the tensile portion of the test would exceed the maximum adhesion force, causing a failure at the adhesive layer. For the dog-bone sample, machining tolerances in the sample holder would cause the sample to slip during the transition from compression to tension. This slippage causes unwanted noise that distorts the strain gauge signals.

Although plastic and metal samples can often be machined to provide a threaded contact with the incident bar 140 and transmission bar 130, highly brittle materials such as concrete do not have this luxury. Stress concentrators in the threading and inhomogeneity in the material itself causes the samples to break at the threads rather than in the gauge section. To overcome these issues, two alternative mechanisms for holding the test samples were examined. A collet and a cylindrical epoxy holder were pursued in parallel as viable alternatives. These approaches rely on friction and adhesion, respectively, between the sample holder and the sample, securing the sample position during both compression and tension test stages. A key benefit of both sample gripping modalities is their employment of cylindrical samples, significantly reducing machining and diminishing sample stress concentrators.

The specimen holder presented builds upon the traditional adhesion method, but it increases the surface area that is used to grip the specimen. This holder utilizes a threaded coupler, a steel pipe, and anchoring epoxy to grasp the sample and connect it to the incident bar 140 and transmission bar 130. The sample travels through a steel pipe filled with epoxy up to a specified depth, then the pipe is threaded into the coupler until the sample is pushed flush against the coupler. The coupler is, in turn, threaded to the incident bar 140 or transmission bar 130.

### 2.3 Precompression Hydraulics

The required precompression load is substantial, and similar approaches in the past have required symmetrical tie rod assemblies that are difficult to use. The new approach utilizes precision tables with connections that are able to carry the high level of precompressive stresses, thus simplifying the experimental setup. The load is then controlled in an automated hydraulic setup with a custom intensifier to carefully control the loading/unloading and level of prestress in the system. The spring concept mentioned for simplifying pulse shaping can also be adjusted for different stiffness levels based on the desired precompressive stress.

FIG. 8 is a cross-sectional view of a precompression hydraulic chamber 810 of the precompression hydraulics 120. A precompression hydraulics 120 at the end of the transmission bar 130 is configured to provide the quasi-static precompressive load to the test specimen 700. A quasi-static load is implemented by increasing the pressure very slowly. The static load carrying capability of a material/component/system can be determined through quasi-static mechanical testing. A seal-plug 820 is configured to accept the transmission bar 130 into the chamber 810 and seal both the inside diameter of the chamber 810 and the outside diameter of the transmission bar 130. The seal-plug 820 provides a high-pressure tight-fitting seal. A high-precision fitting ensures accuracy and repeatability.

Similarly, the precompression hydraulic chamber end plug 830 is configured to seal the inside diameter of the chamber 810 and allow for the transmission bar 130 to be replaced without having to remove the incident bar 140 (if necessary). The axial load on the end of the transmission bar 130 will place a net precompression force on the bar/test specimen/incident bar/barrel/reaction spring/reaction mass load-path. To resist this force, the precompression hydraulic chamber 810 and reaction mass 160 (see FIG. 4) are bolted firmly to the optical tables of the test platform 110. Buckling is not a concern for this system due to the relatively low overall forces applied through the load path. It is noted that different spring configurations can be applied to the reaction mass system 160 to allow for resistance adjustability depending upon the material being tested. Also, the reaction mass 160 contains provisions to allow the striker bar 204 to be loaded/unloaded without disassembly of the barrel/valve assembly (202, 210).

An important design consideration for using a low-stiffness reaction spring 230, instead of a rigid, solid backstop, to resist the compressive force is that the spring will provide minimal resistance to the subsequent dynamic tensile loading pulse, therefore allowing a significant portion of the stress wave to pass into the tension bar system. A rigid backstop, conversely, would limit the overall translation of the system during the preloading phase, and would absorb a significant portion of the impact pulse and therefore greatly reduce the amplitude the tensile wave as well as the effectiveness of the pulse-shaping technique. Based upon an analysis of different specimen materials, a maximum quasi-static hydraulic pressure of 100 MPa was determined to be sufficient. Most commercially available hydraulic systems can apply only 23 MPa of hydraulic pressure, therefore, a pressure intensifier is required to boost the hydraulic pressure up to a maximum operating pressure of 100 MPa.

FIG. 9A shows a first perspective view of a pressure intensifier. FIG. 9B shows a second perspective view thereof. FIG. 9C shows a cross-sectional view thereof. The pressure intensifier 900 is configured to boost the hydraulic pressure (e.g., from 23 MPa to 100 MPa). The pressure intensifier 900 includes an intensifier piston 910 movable inside an intensifier chamber 920. The intensification is accomplished through equilibration of force across two surfaces with different cross-sectional areas, namely, from a larger cross-sectional area 930 (low pressure chamber for low pressure input) to a smaller cross-sectional area 940 (high pressure chamber for high pressure output). Specifically, the intensifier piston, will convert 23 MPa of low pressure from a COTS pumping system to a higher pressure (e.g., 100 MPa) output through the change in cross-sectional area across the piston.

The precompression of the precompression Kolsky tension bar technique provides an additional deformation buffer for accelerating the specimen strain-rate during the subsequent tension, so that a higher tensile strain-rate can be achieved compared to what is possible from regular uniaxial tension devices. To explore the feasibility of this new technique, a series of preliminary studies were carried out on several key design features that were considered to be a risk to the feasibility of this system using a regular uniaxial Kolsky tension bar system. Although the precompressive stress was not applied, the studies laid the foundation for the precompression technique by establishing essential technologies such as a reliable specimen gripping mechanism, pulse-shaping for constant strain-rate deformation, and dynamic stress equilibrium for the tensile specimen. These technologies have never before been realized on any Kolsky tension bar testing of brittle materials.

### 2.4 Tensile Grips

To accommodate the unique loading mechanism of the Kolsky tension bar technique, the specimen attachment method should be relatively simple yet robust. Therefore, an overly complicated specimen and adapter design should be avoided, while at the same time the interfaces of engagement should be minimized to reduce complications from wave reflections. Considering these goals, a simple cylindrical cup design is configured for the tensile grip.

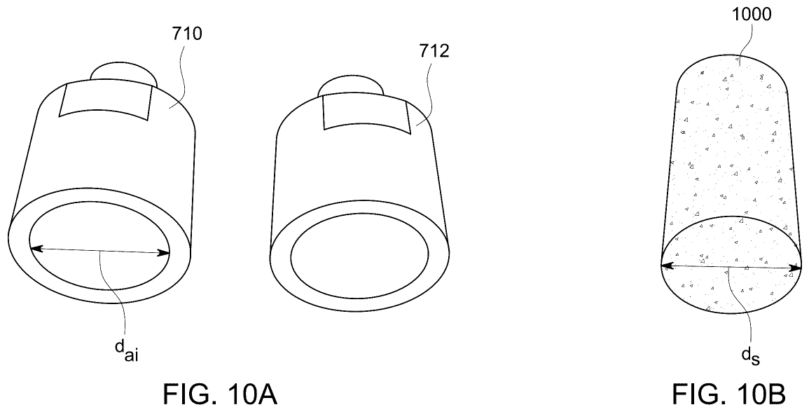

FIG. 10A shows tensile grips 710, 712. FIG. 10B shows a cylindrical concrete tensile specimen 1000. One side of the grip can be threaded into the Kolsky tension bar end, while the cylindrical cup on the other side will hold the tensile specimen through the application of fast-curing epoxy glue. The grips may be made of 7075 aluminum alloy with an inner diameter dₐᵢ of 0.7735″ to accommodate the specimen.

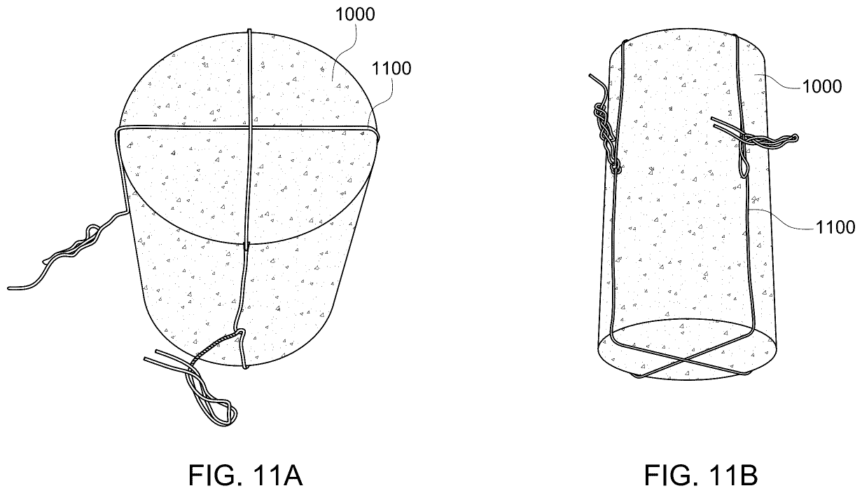

FIG. 11 shows (A) a first perspective view and (B) a second perspective view of the cylindrical concrete tensile specimen 1000 with thin copper wires 1100 attached thereto. This allows the specimen 1000 to be centered precisely inside the cylindrical adapter (same as specimen mount 720) for even epoxy application.

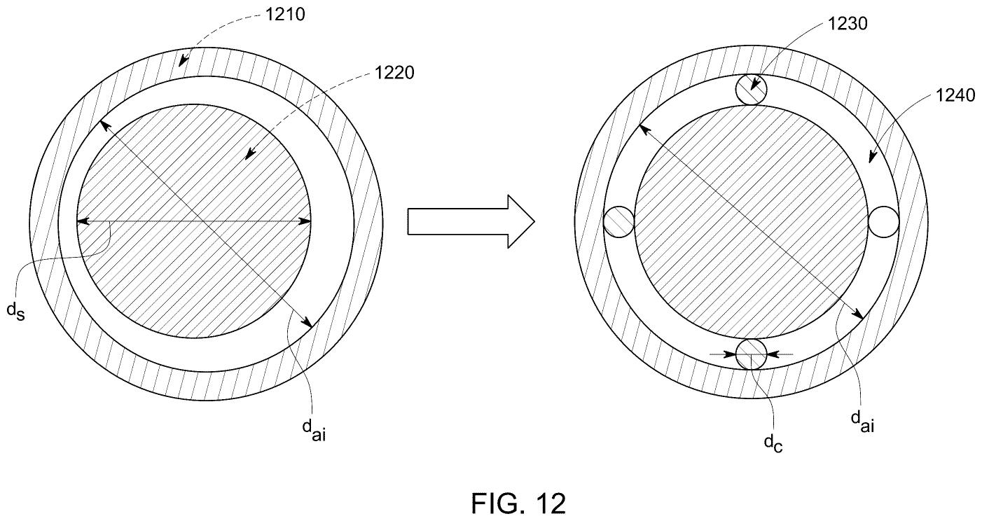

FIG. 12 schematically illustrates the use of the copper wire as a spacer to adjust the specimen position of the specimen inside the adapter. After measuring the inner diameter dₐᵢ of the adapter 1210 and the specimen diameter dₛ of the specimen 1220, copper wires 1230 with the diameter d_{c} slightly larger than the gap 1240 of (dₐᵢ- d_{c})/2 was selected. The two open ends of a single wire were twisted together in the middle section of the specimen 1220, and the joint was placed as close to the specimen surface as possible (see FIG. 11). With this process, the portion of the wire (including the joint) exposed in the specimen gauge section can be later removed after the entire assembly is attached to the Kolsky tension bar system. To secure the attachment between the specimen 1220 and the adapter 1210, a suitable adhesive such as an epoxy glue may be used. An example is Loctite HY 4090, which is a 2-part (one-part epoxy and one-part cyanoacrylate) hybrid structural bonder. The two parts can be applied using a Loctite manual applicator with a 1:1 volume ratio and then mixed using a wooden stick. The mounting concept is to use the uniform copper wires as spacers between the specimen 1220 and the adapter 1210, so that the specimen 1220 is automatically centered after slipping into the adapter 1210. As such, the wire 1100 is configured to be wrapped around a portion of the specimen 1220 to center the specimen 1220 relative to the grip cavity 720 for even epoxy application between the specimen 1220 and the grip cavity 720.

FIG. 13 illustrates a step-by-step procedure of attaching the specimen to the Kolsky tension bar, which has been aligned in advance. In step (1), the inner surface of the adapter and the outer surface of the specimen with approximately ⅓ of its axial length from each end are coated with fully mixed adhesive. In step (2), the specimen is gently inserted into the adapter until it reached full depth. In step (3), this single adapter/specimen assembly is then attached to the end of the incident bar 140 (on the right) with the other adapter being attached to the end of the transmission bar 130 (on the left). In step (4), this attachment process is repeated on the other adapter on the transmission bar side as well as the specimen surface when needed. In step (5), the transmission bar 130 (on the left) is carefully brought forward to completely engage the adapter with the specimen (in the middle).

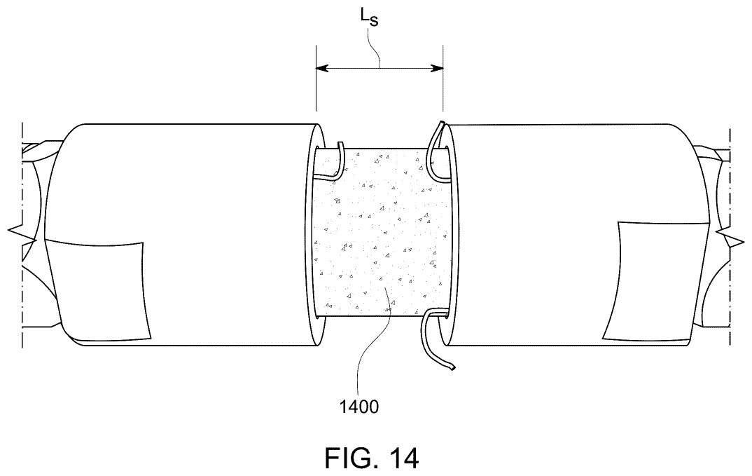

FIG. 14 shows a specimen 1400 attached to the Kolsky tension bar. A curing process, such as a full 24-hour curing period, is employed for the epoxy to achieve its maximum strength. Once the epoxy is fully cured, the thin copper wires within the specimen gauge section are removed and the final measurement of specimen gauge length, Lₛ, can be made. The specimen is ready for testing.

Three preliminary tensile tests were conducted on the Kolsky tension bar specimen. These tests were used not only to obtain tensile mechanical properties but also to verify the effectiveness of the epoxy and grip design for specimen attachment.

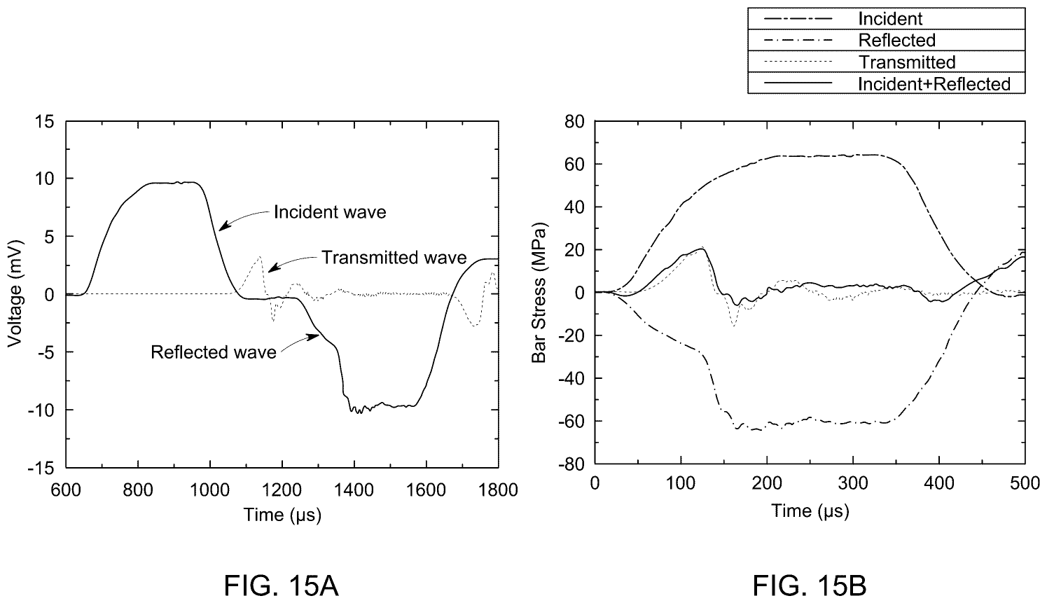

FIG. 15A shows a typical set of waveforms recorded from one of the dynamic tensile tests including original oscilloscope records of voltage. FIG. 15B shows a typical set of waveforms including corresponding shifted waveforms for a proof-of-concept dynamic tensile test of concrete of bar stress. The incident wave was not particularly pulse-shaped to achieve constant strain-rate deformation of the specimen at this time. The test specimen appeared to have maintained reasonably good stress equilibrium during the entire tensile loading process even under non-ideal loading pulses. Although the strain-rate history was not quite constant yet, the reflected wave profile nevertheless suggested a promising feature that slight adjustments of the loading ramp may eventually produce the desired constant strain rate conditions.

Out of the three specimens, only the first one fractured inside the adapter while the other two specimens broke within the gauge section. Also, none of the three specimens showed any sign of epoxy debonding. These results indicate that the Loctite HY 4090 hybrid epoxy is an ideal candidate for this tensile gripping technique.

Testing concrete in tension has been challenging for many years, even at slow rates, because the material is very brittle while also being weak in tension. The Kolsky bar further complicates this approach as there are no degrees of freedom and specimen alignment has extremely tight tolerances to avoid specimen bending. The proposed gripping solution addresses all major concerns and has demonstrated success with relatively high strain rates that will be increased through the development of the precompressive solution.

### 2.5 Pulse Shaping

The foundational requirements of any Kolsky bar experiment are achieving a constant strain rate while the entire specimen is under dynamic stress equilibrium. Without satisfying these requirements, the fundamental wave equations used for data processing are not valid. Therefore, pulse shaping is frequently implemented to satisfy these requirements. However, the addition of a precompression system for the entire Kolsky bar system greatly complicates the pulse shaping approach. The innovative design implements a stiff spring 230 so that a single pulse shaper 402 can be used. Furthermore, the pulse shaper can be easily attached through a carefully designed access portal 404 in the gun barrel 202, allowing for more rapid pulse shaper design and subsequent testing without the need for any disassembly of the gas gun.

To investigate the pulse-shaping technique for generating constant strain-rate deformation, a linear ramp loading pulse was used. Through several iterations, a single, annealed-copper, pulse-shaper with a diameter of 4 mm and a thickness of 0.8 mm produces an ideal loading pulse for a 0.75-inch diameter high-performance concrete (HPC) specimen.

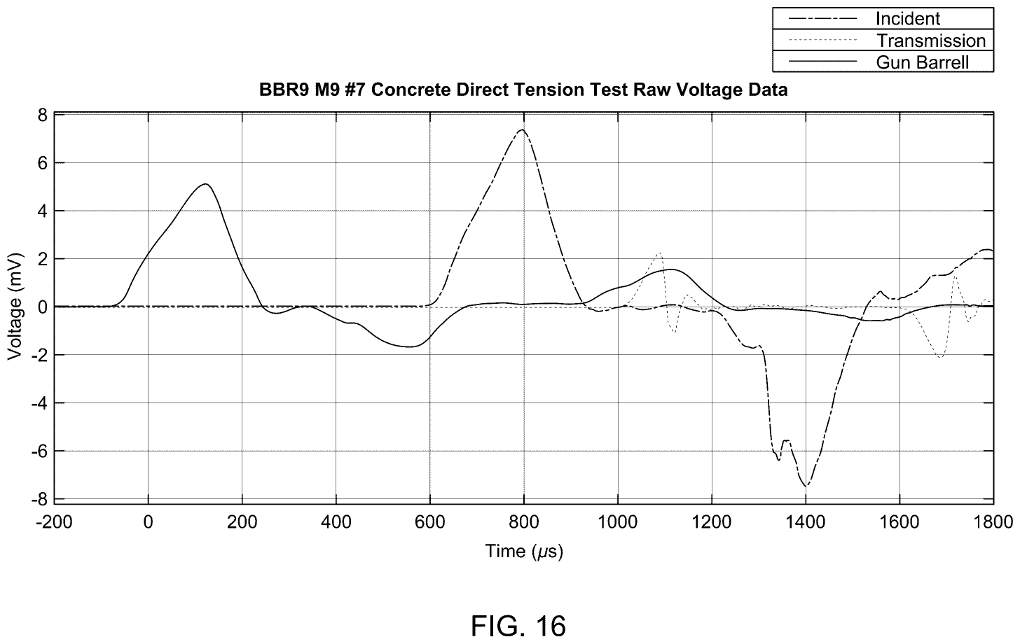

FIG. 16 shows the original raw strain gauge signal from a dynamic uniaxial tensile test of HPC specimens. The reflected wave clearly shows a plateau before the catastrophic failure of the specimen. These results serve as solid evidence that constant strain-rate deformation can be achieved for dynamic tension of brittle materials through careful pulse-shaping.

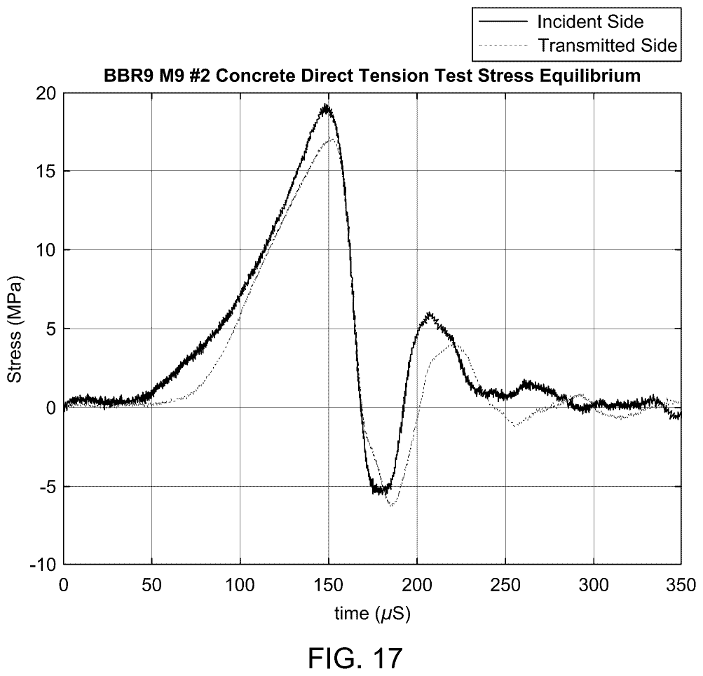

FIG. 17 shows the dynamic stress equilibrium check for the dynamic tensile test. Evidently, the stress on both sides of the specimen gauge section rises in near-unison, and the difference between the two stress histories remain relatively small compared to the intrinsic strength (indicated by the transmitted wave) of the material. It is worth noting that the stress signals presented in FIG. 17 have not been corrected of the inertia effects of the specimen adapters. Such correction becomes necessary if the incident and transmitted pulses present non-constant stress profiles and, therefore, non-constant particle velocities. Additional stresses introduced by the acceleration/deceleration of the specimen adapters 1210 may be non-trivial considering the low tensile failure strength of concrete. Once these inertia forces are compensated in the measured signals, the stress equilibrium profiles are expected to show even better correlation between the incident and transmission bar signals.

With this initial success, four uniaxial dynamic tensile tests were performed on an HPC material. The pulse-shaping technique was proven to be very reliable with a constant strain-rate deformation being produced under each test.

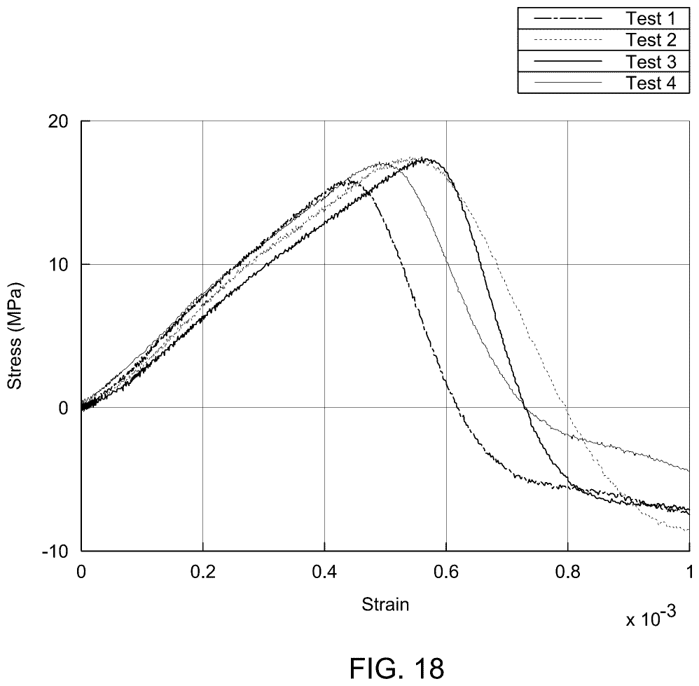

FIG. 18 shows the tensile stress-strain curves of the four specimens at the strain rate of ˜7/s. These test results are considered quite consistent for concrete. The dynamic tensile failure stress for this HPC ranges between 15 MPa and 18 MPa, with an average tensile failure strain of 0.05%. Such repeatability in the measurement of tensile stress-strain behavior for concrete is rarely reported even under quasi-static loading conditions. These results are believed to be the very first set of Kolsky bar dynamic tensile properties for concrete measured under constant strain-rate deformation and dynamic stress equilibrium.

The overall objective of the precompression tensile Kolsky bar system development was to design a system with performance, ease-of-use, and reliability in mind. The performance of the system will enable state-of-the-art dynamic tensile experiments on brittle materials to be performed under conditions of stress-equilibrium and high strain-rate levels. The designed system shows thought for the operator and allows for fluid and precise control of the device and permits changes and adjustments to be made in a matter of minutes, not hours. The system is also designed for reliability through the air-gun system 150, laser velocity system 220, hydraulic pumping system 120 and intensifier 900, and tensile grips 710, 712. It is fully expected that the precompression direct Kolsky tensile system will provide the user with world-class technical data on brittle materials that cannot be obtained in any other system and will aide in researchers in studying high-rate behavior of brittle materials.

Experiments were conducted to explore the feasibility of achieving constant strain-rate deformation and dynamic stress equilibrium for the specimen during Kolsky bar uniaxial tensile testing of concrete. The present technique leverages a specially designed specimen adapter with careful pulse-shaping to test brittle materials under ideal dynamic experimental conditions which have not been previously reported elsewhere. The preliminary results obtained under dynamic uniaxial tension are quite encouraging. It is a testimony of the robustness of the proposed technique. To accommodate the addition of precompression, the contact mechanism between the specimen adapter and the Kolsky bar is slightly modified to ensure that the threads are not the main load-bearing components of the compressive force. The pulse-shaper design is reconfigured to generate sufficiently high amplitude tensile pulse to overcome the precompressive stress in the specimen and produce higher constant strain-rate deformations than what was possible with a traditional Kolsky tensile system. The improvements are made without compromising the constant strain-rate deformation and dynamic stress equilibrium for the tensile specimen.

### 3. Method

In embodiments, an elastic axial compressive preload is applied to the test specimen before a dynamic load is applied through the modified tensile Kolsky bar system. During the initial tensile loading of the test specimen from the incident bar 140, the precompressive load on the specimen will be negated while allowing the loading pulse and strain rate to equilibrate load at lower mean values and therefore earlier into the experiment. The design allows the preload to be adjustable to account for different material types and can be applied at a sufficiently low-level to restrict the test specimen from being plastically damaged before the dynamic tensile load is applied.

In drag races, cars are competing with each other to reach a faster speed at the end of a short runway. The major limiting factor in that case is the length of the runway. It is a very similar situation for dynamic tensile testing of brittle materials such as concrete. On the one hand, a high-intensity tensile loading pulse is applied to the concrete specimen through well-established Kolsky bar technique hoping to accelerate its deformation rate (strain rate) as quickly as possible. On the other hand, however, concrete is extremely brittle in tension therefore offering limited tensile deformation (analogous to the runway) before failure occurs.

Just like a severely shortened runway in drag races will limit the final speed of the car, the small tensile failure strain intrinsic to concrete poses a major obstacle in achieving higher tensile strain rate. In light of this, the core of the proposed precompression tension Kolsky bar technique is to artificially increase the “tensile runway” of concrete specimens by applying a precompression before conducting the tensile experiment.

This increase of the “tensile runway” is achieved by placing a hydraulic intensifier (900 in FIGS. 9A-9C) at the end of a conventional Kolsky tension bar and applying static compressive loading to the entire system. The compressive loading causes the specimen (700 in FIG. 7) to deform and maintain an initial precompressed state. A reaction spring (230 in FIGS. 2-4) is placed on the other end (reaction mass section) of the Kolsky bar system to counter the compression from the hydraulic intensifier. Once the desired compressive deformation in the concrete specimen is achieved, the static loading will maintain at the current level until the end of the test.

After successfully extending the artificial “runway” for dynamic tensile testing of concrete specimens by applying precompression, the conventional Kolsky bar will be operated in its usual manner by firing the striker bar (204 in FIGS. 2 and 3) against the impact plug (214 in FIGS. 2-4) to generate a dynamic tensile loading pulse. This loading pulse will travel from the impact end (impact plug 214 in FIGS. 2-4) through the gun barrel (202 in FIGS. 2-4) and into the incident bar (140 in FIGS. 1-3). Once the tensile wave arrives at the precompressed specimen (700 in FIG. 7), the specimen will start to spring back therefore relieving the compressive stress while allowing the tensile strain rate to ramp up. By the time the compressive stress is completely relieved, the tensile strain rate in the specimen has already reached a level otherwise impossible for a conventional Kolsky tension bar test of concrete. On the other end of the Kolsky tension bar setup, the reaction spring (230 in FIGS. 2-4) and reaction spacer (412 in FIG. 4) system is employed to offer the flexibility of adopting springs of different dimensions and/or different stiffnesses as the testing condition changes. The position of the spacer can be adjusted through threads engagement with the rigid block (reaction mass 160 in FIGS. 1-4) to accommodate springs with different length, and the size of the impact plug (214 in FIGS. 2-4) can also be altered based on the diameter of the spring. Furthermore, pulse shapers can be applied onto the impact end of the plug (pulse shaper 402 in FIG. 4) through the laser holes on the end of the gun barrel. This newly designed precompression Kolsky tension bar is by far the only dynamic testing technique to achieve a tensile strain rate for concrete comparable to its dynamic compression counterpart.

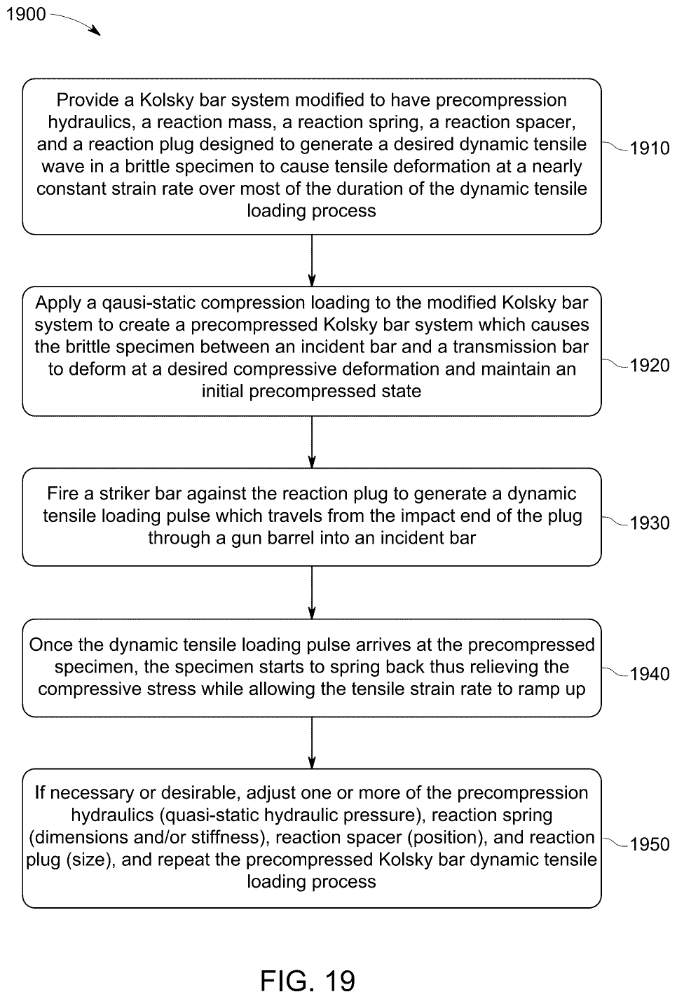

FIG. 19 is a flow diagram 1900 illustrating an example of a precompression tensile Kolsky bar method. In step 1910, a Kolsky bar system is modified to have precompression hydraulics, a reaction mass, a reaction spring, a reaction spacer, and a reaction plug designed to generate a desired dynamic tensile wave in a brittle specimen to cause tensile deformation at a nearly constant strain rate over most of the duration of the dynamic tensile loading process. Step 1920 applies a static compression loading to the modified Kolsky bar system to create a precompressed Kolsky bar system which causes the brittle specimen between an incident bar and a transmission bar to deform at a desired compressive deformation and maintain an initial precompressed state. In step 1930, a striker bar is fired against the reaction plug to generate a dynamic tensile loading pulse which travels from the impact end of the plug through a gun barrel into the incident bar. Once the dynamic tensile loading pulse arrives at the precompressed specimen, the specimen starts to spring back thus relieving the compressive stress while allowing the tensile strain rate to ramp up (step 1940). The dynamic tensile load is applied on the specimen to obtain stress-strain data for the specimen. If necessary or desirable, step 1950 adjusts one or more of the precompression hydraulics (quasi-static hydraulic pressure), reaction spring (different dimension and/or different stiffness), reaction spacer (different position), and reaction plug (different size), and repeat the precompressed Kolsky bar dynamic tensile loading process.

Target structures employing frictional target materials can limit the effectiveness of weapon systems in penetrating the frictional target materials. For instance, the target structures may utilize ultra-high-strength concretes that have unconfined compressive strengths of more than 200 MPa. In order to understand the weapon structural response, the interaction of the target and warhead is vital and is dependent upon not only the physical characteristics of the weapon system (i.e., diameter, mass, material(s), center-of-gravity, etc.) but also the target properties such as density, water content, porosity, strength, cement strength, and aggregate/fiber properties. Additionally, under the scenario of perforation and multi-hit events, the dynamic tensile strength of target materials can play a significant role in determining the penetration resistance since a large volume of materials on the exit side of the target will be subjected to high-intensity dynamic tensile loadings. The ability to accurately characterize the materials response under these conditions is crucial for numerical model development.

The precompression Kolsky tension bar system is uniquely capable of measuring the dynamic properties of brittle materials of interest to the military (e.g., concrete, glass, armor). Through the incorporation of a novel precompressive deformation, the subject material has a longer distance to travel when initiating a dynamic tensile impact to measure material properties at faster rates than have previously been possible. Testing of concretes in this device may aide in hardened structures constitutive modelling efforts for shock environments from penetration and blast events for systems such as hyper-sonic missiles.

Data obtained from the testing techniques described in this disclosure and the subsequent model improvements to computational material models will provide the ability to better predict the performance of current and future weapon systems into new ultra-high-strength concrete materials. The improvement of constitutive models for ultra-high-strength concrete materials will continue to be of interest as militaries increase their use of these specialized cement-based materials. Successful integration of these methodologies and techniques will open up new application areas for added experimental damage morphology studies, penetration testing, and improved instrumentation that will further aide in better predicting the response of target materials during penetration and other shock environments. This research also has direct applications to commercial mining and energy resource industries where explosive blasting techniques can benefit from a better understanding of near-field damage morphology of mining materials. Directional detonation enhancements could optimize drill hole patterns and increase yield and productivity in this industry.

Embodiments of the invention can be manifest in the form of methods and apparatuses for practicing those methods. As compared to the traditional Kolsky bar, the benefits of implementing this technology include the ability to measure the dynamic properties of brittle materials including ultra-high-strength concrete materials.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A loading apparatus comprising:
an incident bar and a transmission bar coaxial with a specimen along a longitudinal axis to be loaded in a direction along the longitudinal axis, the incident bar and the transmission bar being coupled to the specimen on opposite sides of the specimen, the incident bar and the transmission bar being supported on a platform;
a loading gun having a gun barrel and a striker bar inside the gun barrel which are coaxial with the incident bar, the gun barrel being coupled to the incident bar, the incident bar being disposed between the gun barrel and the specimen, the gun barrel being supported on the platform;
a reaction mass mounted on the platform;
a reaction spring disposed between and coupled with the gun barrel and the reaction mass;
a pulse shaper disposed between the reaction spring and the striker bar, the striker bar configured to be propelled in a direction from the incident bar to the reaction spring to strike the pulse shaper and compress the reaction spring to apply a dynamic tensile load on the specimen in the direction along the longitudinal axis; and
a precompression device coupled to the transmission bar which is disposed between the specimen and the precompression device, the precompression device configured to apply a quasi-static precompressive load on the specimen in the direction along the longitudinal axis via the transmission bar prior to propelling the striker bar to the pulse shaper to apply the dynamic tensile load on the specimen.

2. The loading apparatus of claim 1, further comprising:
a reaction spacer between the reaction spring and the reaction mass; and
a reaction plug between the reaction spring and the pulse shaper;
wherein the reaction spacer and the reaction plug are replaceable to change the reaction spring in a modular manner to change the dynamic tensile load to be applied to the specimen.

3. The loading apparatus of claim 1,
wherein the pulse shaper is configured, upon impact by the striker bar, to generate an incident pulse in the incident bar and transmit the incident pulse to apply the dynamic tensile load on the specimen to obtain stress-strain data for the specimen; and
wherein the pulse shaper is configured to shape the incident pulse in the incident bar to load the specimen in dynamic stress equilibrium at a substantially constant strain-rate deformation over a substantial portion (most) of a loading duration of the dynamic tensile load on the specimen.

4. The loading apparatus of claim 1,
wherein the precompression device comprises a precompression hydraulic chamber configured with a pressure intensifier.

5. The loading apparatus of claim 4,
wherein the pressure intensifier is configured to generate a pressure of about 100 MPa in the precompression hydraulic chamber.

6. The loading apparatus of claim 1, further comprising:
a pair of tensile grips to grip the specimen at opposite ends of the specimen along the longitudinal axis, each tensile grip including a grip cavity to receive a portion of the specimen to be glued to the grip cavity and a threaded end to threadingly receive a portion of the incident bar or the transmission bar.

7. The loading apparatus of claim 6, further comprising:
a wire configured to be wrapped around a portion of the specimen to center the specimen relative to the grip cavity for even epoxy application between the specimen and the grip cavity.

8. A dynamic tensile loading method, comprising:
connecting an incident bar and a transmission bar on opposite sides of a specimen which is coaxial with the incident bar and the transmission bar along a longitudinal axis to be loaded in a direction along the longitudinal axis;
connecting a loading gun to the incident bar, the loading gun having a gun barrel and a striker bar inside the gun barrel which are coaxial with the incident bar, the gun barrel being coupled to the incident bar, the incident bar being disposed between the gun barrel and the specimen;
mounting a reaction mass on a platform;
connecting a reaction spring between the gun barrel and the reaction mass;
applying a quasi-static precompressive load to the specimen in the direction along the longitudinal axis via the transmission bar to provide a precompressed specimen; and
propelling the striker bar in a direction from the incident bar to the reaction spring to strike and compress the reaction spring to apply a dynamic tensile load on the specimen in the direction along the longitudinal axis.

9. The dynamic tensile loading method of claim 8, further comprising:
placing a pulse shaper between the reaction spring and the striker bar,
wherein the striker bar is propelled in the direction from the incident bar to the reaction spring to strike the pulse shaper and compress the reaction spring to apply the dynamic tensile load on the specimen in the direction along the longitudinal axis.

10. The dynamic tensile loading method of claim 9, further comprising:
connecting a reaction spacer between the reaction spring and the reaction mass; and
connecting a reaction plug between the reaction spring and the pulse shaper;
wherein the reaction spacer and the reaction plug are replaceable to change the reaction spring in a modular manner to change the dynamic tensile load to be applied to the specimen.

11. The dynamic tensile loading method of claim 10, further comprising replacing one or more of:
the reaction plug having a different size;
the reaction spacer to change a position of the reaction spring; and
the reaction spring having at least a different dimension or a different stiffness to change the dynamic tensile load to be applied to the specimen.

12. The dynamic tensile loading method of claim 9,
wherein the pulse shaper is configured, upon impact by the striker bar, to generate an incident pulse in the incident bar and transmit the incident pulse to apply the dynamic tensile load on the specimen to obtain stress-strain data for the specimen; and
wherein the pulse shaper is configured to shape the incident pulse in the incident bar to load the specimen in dynamic stress equilibrium at a substantially constant strain-rate deformation over a substantial portion (most) of a loading duration of the dynamic tensile load on the specimen.

13. The dynamic tensile loading method of claim 9, further comprising:
coupling a precompression device to the transmission bar, which is disposed between the specimen and the precompression device, to apply the quasi-static precompressive load on the specimen in the direction along the longitudinal axis via the transmission bar prior to propelling the striker bar to the pulse shaper to apply the dynamic tensile load on the specimen.

14. The dynamic tensile loading method of claim 13,
wherein the precompression device comprises a precompression hydraulic chamber configured with a pressure intensifier.

15. The dynamic tensile loading method of claim 14,
wherein the pressure intensifier is configured to generate a pressure of about 100 MPa in the precompression hydraulic chamber.

16. The dynamic tensile loading method of claim 8, further comprising:
gripping the specimen with a pair of tensile grips at opposite ends of the specimen along the longitudinal axis, each tensile grip including a grip cavity to receive a portion of the specimen to be glued to the grip cavity and a threaded end to threadingly receive a portion of the incident bar or the transmission bar.

17. The dynamic tensile loading method of claim 16, further comprising:
wrapping a wire around a portion of the specimen to center the specimen relative to the grip cavity for even epoxy application between the specimen and the grip cavity.

18. A loading apparatus comprising:
an incident bar and a transmission bar coaxial with a specimen along a longitudinal axis to be loaded in a direction along the longitudinal axis, the incident bar and the transmission bar being coupled to the specimen on opposite sides of the specimen;
a loading gun having a gun barrel and a striker bar inside the gun barrel which are coaxial with the incident bar, the gun barrel being coupled to the incident bar, the incident bar being disposed between the gun barrel and the specimen;
a reaction mass;
means coupled to the reaction mass for receiving impact by the striker bar and, in response thereto, generating an incident pulse in the incident bar and transmit the incident pulse to apply a dynamic tensile load on the specimen; and
a precompression device coupled to the transmission bar which is disposed between the specimen and the precompression device, the precompression device configured to apply a quasi-static precompressive load on the specimen in the direction along the longitudinal axis via the transmission bar prior to propelling the striker bar to the means to apply the dynamic tensile load on the specimen.

19. The loading apparatus of claim 18,
wherein the means comprises means for generating the incident pulse to apply the dynamic tensile load on the specimen in dynamic stress equilibrium at a substantially constant strain-rate deformation over a substantial portion (most) of a loading duration of the dynamic tensile load on the specimen.

20. The loading apparatus of claim 18,
wherein the means comprises modular means which are replaceable in a modular manner to adjust the incident pulse generated in response to receiving impact by the striker bar for different specimens, for applying the dynamic tensile load on the specimen in dynamic stress equilibrium at a substantially constant strain-rate deformation over a substantial portion (most) of a loading duration of the dynamic tensile load on the different specimens.
